(19) United States
(12) Patent Application Publication
(10) Pub. No.: US 2015/0116337 A1
(43) Pub. Date: Apr. 30, 2015

(54) DISPLAY DEVICE AND SCREEN KEEP-ALIVE CONTROLLING METHOD THEREOF

(71) Applicant: HTC CORPORATION, Taoyuan County (TW)

(72) Inventors: Hsin-Ti CHUEH, TAOYUAN COUNTY (TW); Abhishek SAXENA, TAOYUAN COUNTY (TW); Chia-Wei CHEN, TAOYUAN COUNTY (TW); Chen-Huang FAN, TAOYUAN COUNTY (TW)

(73) Assignee: HTC CORPORATION, Taoyuan County (TW)

(21) Appl. No.: 14/063,378

(22) Filed: Oct. 25, 2013

(51) Int. Cl. G06F 1/32; G09G 5/00

(52) U.S. Cl. CPC G06F 1/3265; G09G 5/006; G06F 1/3218; G09G 2330/022
USPC 345/522

(57) ABSTRACT

A display device and a screen keep-alive controlling method thereof are provided. The display device includes a processor and a screen electrically connected with the processor. The processor is configured to determine a display period of information according to complexity of the information, while the screen is configured to keep the information alive during the display period. The screen keep-alive controlling method is applied to the display device to implement the aforesaid operations.

### FIELD OF THE INVENTION

The present invention relates to a display device. In particular, the present invention relates to a display device and a screen keep-alive controlling method thereof that can control a keep-alive period of a screen.

### DESCRIPTION OF THE RELATED ART

Green energy technologies have become of great importance with the shortage of usable energy resources, abnormal change of climate and environment pollution around the world. In response to the trend of green energy technologies, electronic products are also designed to save energy. In electronic products, display devices (e.g., the cathode ray tube (CRT) displays, liquid crystal displays (LCD), touch screens or the like) are used to present information to users. To save electric energy, conventional display devices allow a user to set a display period during which information is displayed by the display device to the user and, once the display period expires, displaying of the information is stopped. Generally, the behavior of displaying information to the user during the display period is called the “keep-alive behavior.”

Although the display device is kept from always being active by setting the display period to save energy, the display period that is set is invariable, which makes it inconvenient for the user to acquire information. In detail, if the display period is set to be too short, it will be difficult for the user to completely acquire the necessary information during the display period; and in this case, the user must manually activate the display device again to continue to acquire the remaining information. On the other hand, if the display period is set to be too long, it is likely that the user might have already completely acquired the necessary information before the display period expires; and in this case, the user must manually deactivate the display for the purpose of saving energy.

Accordingly, it is important to overcome the problem in conventional display devices in which the user cannot effectively acquire information when a display period is set to save energy.

### CONTENTS OF THE INVENTION

The primary objective of the present invention is to overcome the problem in conventional display devices in which the user cannot effectively acquire information when a display period is set to save energy. Generally, the time necessary for the user to acquire information from the display device is highly related to the complexity of the information. In principal, the more complex the information, the longer the time necessary for the user to acquire the information from the display device. Similarly, the less complex the information is, the shorter the time necessary for the user to acquire the information from the display device. Therefore, the present invention provides a display device with a function of determining the display period of information according to the complexity of the information so that the difference between the time necessary for the user to acquire the information from the display device and the display period in which the information is displayed by the display device can be reduced. In this way, the aforesaid objective of the present invention can be achieved.

To achieve the aforesaid objective, the present invention provides a display device. The display device comprises a processor and a screen electrically connected to the processor. The processor is configured to determine a first display period of information according to complexity of the information. The screen is configured to keep the information alive during the first display period.

To achieve the aforesaid objective, the present invention further provides a screen keep-alive controlling method for a display device. The display device comprises a processor and a screen electrically connected to the processor. The screen keep-alive controlling method comprises the following steps:

(a) enabling the processor to determine a first display period of information according to complexity of the information; and

(b) enabling the screen to keep the information alive during the first display period.

The detailed technology and preferred embodiments implemented for the subject invention are described in the following paragraphs accompanying the appended drawings for persons skilled in this field to well appreciate the features of the claimed invention.

### BRIEF DESCRIPTION OF THE DRAWINGS

FIG. 1 is a schematic structural view of a display device according to a first embodiment of the present invention; and

FIG. 2 is a flowchart diagram of a screen keep-alive controlling method according to a second embodiment of the present invention.

### DESCRIPTION OF EMBODIMENTS

In the following description, the present invention will be explained with reference to embodiments thereof. However, these embodiments are not intended to limit the present invention to any specific environment, applications or particular implementations described in these embodiments. Therefore, the description of these embodiments is only for purpose of illustration rather than limitation. It should be appreciated that in the following embodiments and attached drawings, elements unrelated to the present invention are omitted from the depiction. In addition, Dimensional relationships among the individual elements in the attached drawings are illustrated only for the ease of understanding, but not to limit the actual scale.

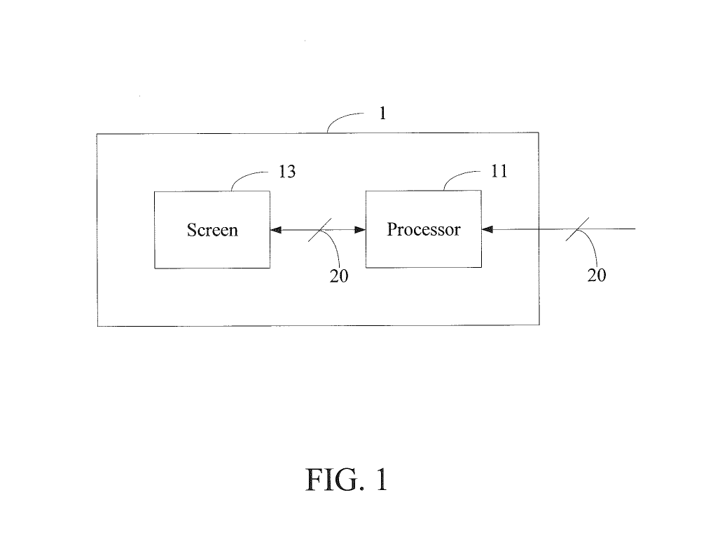

A first embodiment of the present invention relates to a display device. A schematic structural view of the display is shown in FIG. 1. As shown in FIG. 1, the display device 1 comprises a processor 11 and a screen 13 electrically connected with the processor 11. Essentially, the display device 1 may be an electronic device with a display function, such as a cathode ray tube (CRT) display, a liquid crystal display (LCD), a touch screen or the like. Depending on different application scenarios, the display device 1 may interact with a host in such devices as a personal computer, a tablet computer, a notebook computer, a digital camera, a personal digital assistant (PDA) or a mobile phone to display information that is to be displayed by the host to the user.

The processor 11 is configured to determine a first display period of information 20 according to complexity of the information 20. The screen 13 is configured to keep the information 20 alive during the first display period. The information 20 is visual information, and comprises one or a combination of text, picture and/or video information. The text information broadly refers to various texts/paragraphs, symbols, numerals or combinations thereof, and is not limited to any specific language. The picture information broadly refers to various images, scenes, photos or the like, and is not limited to any specific format. The video information broadly refers to various motion pictures as well as combinations of continuous images, continuous scenes or continuous photos, and is not limited to any specific format.

Furthermore, the complexity of the information 20 is related to properties of the information 20. The properties of the information 20 may include but are not limited to the following: the information size, the typesetting manner, the readability, etc. Generally, the larger the information size, the messier typesetting or lower readability of the information 20 leads to a longer time necessary for the user to completely acquire the information 20. Conversely, the smaller the information size, the less messy typesetting or higher readability of the information 20 leads to a shorter time necessary for the user to completely acquire the information 20.

The processor 11 can retrieve the text, picture and/or video information comprised in the information 20 through analyzing contents of the information 20. Then, the processor 11 determines the times necessary for the user to read the text, picture and/or video information respectively according to such properties as the information size, typesetting manner and readability to estimate the time necessary for the user to completely acquire the information 20. For example, assume that the information 20 comprises one hundred words, ten pictures and two videos, and the processor 11 determines that the times necessary for the user to read each word, each picture and each video are one tenth seconds, two seconds and 10 seconds respectively. Then, the time necessary for the user to completely acquire the information 20 is estimated by the processor 11 to be fifty seconds. The method in which the information 20 is analyzed to retrieve the text, picture and/or video information comprised therein is well known to those of ordinary skill in the art, so this will not be further described herein.

On the other hand, the properties of an application corresponding to the information 20 has an influence on the form of the information 20, while the information 20 with various forms has an influence on the time necessary for the user to completely acquire the information 20. If the information 20 corresponds to a text processing application (e.g., Microsoft Office), then the information 20 may be considered as file contents executed by the text processing application. If the information 20 corresponds to a web browsing application (e.g., Microsoft Internet Explorer), then the information 20 may be considered as web contents browsed via the web browsing application. If the information 20 corresponds to a media playing application (e.g., Microsoft Media Player), then the information 20 may be considered as media contents played by the media playing application.

Thus, the processor 11 can determine a first display period according to the complexity of the information 20 and/or the properties of the application to estimate the time necessary for the user to completely acquire the information 20. In detail, the processor 11 can roughly determine the first display period of the information 20 according to the properties of the application corresponding to the information 20. The processor 11 can also accurately estimate the first display period of the information 20 according to the complexity of the information 20, with the first display period being in direct proportion to the complexity of the information 20. Once the first display period of the information 20 is determined by the processor 11, the screen 13 can learn the first display period of the information 20 from the processor 11 and display the information 20 during the first display period. In other words, the screen 13 will keep the information 20 alive during the first display period.

To adaptively estimate the time necessary for the user to completely acquire the information 20, the display device 1 may optionally execute the following operations. In detail, the processor 11 may adaptively adjust the display period of the information 20 so that the display period in which the screen 13 keeps the information 20 alive is closer to the time necessary for the user to completely acquire the information 20.

Furthermore, if a display interrupt event takes place during the first display period in which the screen 13 keeps the information 20 alive, this means that the user might have completely acquired the information 20 before the first display period expires. In this case, the processor 11 will shorten the first display period of the information 20 to be a second display period. The screen 13 will keep the information 20 alive according to the second display period instead of the first display period. In other words, the screen 13 will keep the information 20 alive during the second display period. The display interrupt event includes various operations that enable the screen 13 to stop displaying the information 20, for example, but is not limited to the following: the user manually depresses the power key to turn off the screen 13; and the user puts down the electronic device comprising the display device 1; and etc..

For example, if the first display period of the information 20 is 50 seconds and the user manually depresses the power key to turn off the screen 13 ten seconds before the first display period expires, then the processor 11 determines the second display period to be 40 seconds. Then, the screen 13 will keep the information 20 alive within 40 seconds when the information 20 is displayed the next time by the display device 1.

Additionally, if a display keep-on event takes place after the first display period, this means that the information 20 might have not been completely acquired by the user yet when the first display period expires. In this case, the processor 11 will extend the first display period of the information 20 to be a third display period. The screen 13 will display the information 20 during the third display period instead of the first display period. In other words, the screen 13 will keep the information 20 alive during the third display period when the information 20 is displayed the next time. The display keep-on event includes various operations that enable the screen 13 to extend the time duration of displaying the information 20, for example is but not limited to the following: when the electronic device comprising the display device 1 is able to be viewed by the user, the user manually depresses the power key to turn on the screen 13; the user shakes the electronic device comprising the display device 1 to turn on the screen 13; etc . . .

For example, if the first display period of the information 20 is fifty seconds and the user manually depresses the power key to turn on the screen 13 after the screen 13 is turned off when the first display period has expired and, ten seconds later, manually depresses the power key to turn off the screen 13 again, then the processor 11 determines the second display period to be sixty seconds. The screen 13 will keep the information 20 alive within sixty seconds when the information 20 is displayed the next time by the display device 1.

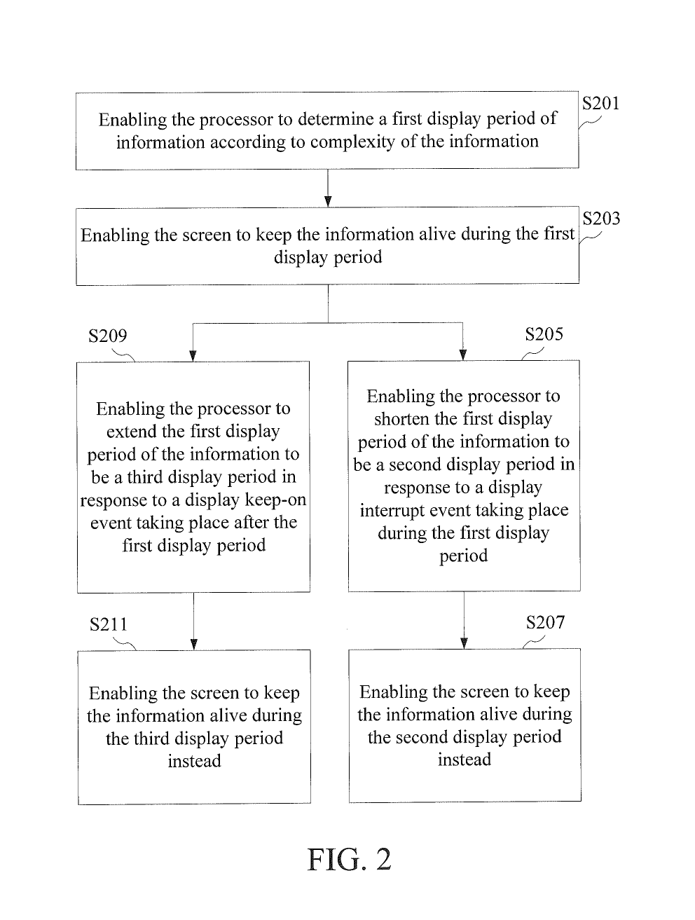

A second embodiment of the present invention provides a screen keep-alive method for a display device. A flowchart diagram of the screen keep-alive method is shown in FIG. 2. The display device described in this embodiment may substantially be considered as the display device 1 described in the first embodiment. The display device described in this embodiment may comprise a processor and a screen electrically connected to the processor.

As shown in FIG. 2, in step S201, a first display period of information is determined by the processor according to complexity of the information. In other embodiments of the present invention, step S201 may be the following: enabling the processor to determine the first display period according to the complexity of the information and properties of an application corresponding to the information. In step S203, the information is kept alive by the screen during the first display period.

In principal, the screen keep-alive controlling method of this embodiment may only comprise step S201 and step S203. However, to allow the display device to adaptively estimate the time necessary for the user to completely acquire the information, the screen keep-alive method of this embodiment may further comprise the following steps. In detail, in step S205, the first display period of the information is shortened by the processor to be a second display period in response to a display interrupt event taking place during the first display period. Then, in step S207, the information is kept alive by the screen during the second display period instead. Furthermore, in step S209, the first display period of the information is extended by the processor to be a third display period in response to a display keep-on event taking place after the first display period. Then, in step S211, the information is kept alive by the screen during the third display period instead.

In addition to the aforesaid steps, the second embodiment can also execute all the steps of the operations of the display device 1 set forth in the first embodiment. The method in which the screen keep-alive method of this embodiment executes these steps will be readily appreciated by those of ordinary skill in the art based on the explanation of the first embodiment, and thus, will not be further described herein.

The above disclosure is related to the detailed technical contents and inventive features thereof. Persons skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

### BRIEF DESCRIPTION OF REFERENCE NUMERALS

1: display device

11: processor

13: screen

20: information

S201, S203, S205, S207, S209 and S211: steps

### BIOLOGICAL MERERIAL DEPOSIT

Local Deposit Information [Please indicate deposit institute, date and number in order]

Foreign Deposit Information [Please indicate deposit country, institute, date and number in order]

### SEQUENCE TABLE

(Please recite in separate sheet)

What is claimed is:

1. A display device, comprising:
a processor, being configured to determine a first display period of information according to complexity of the information; and
a screen electrically connected to the processor, being configured to keep the information alive during the first display period.

2. The display device as claimed in claim 1, wherein the information comprises one or a combination of text information, picture information and video information.

3. The display device as claimed in claim 1, wherein the first display period is directly proportional to the complexity of the information.

4. The display device as claimed in claim 1, wherein the information corresponds to an application, and the processor is configured to determine the first display period according to the complexity of the information and properties of the application.

5. The display device as claimed in claim 1, wherein the processor shortens the first display period of the information to be a second display period in response to a display interrupt event taking place during the first display period, and the screen keeps the information alive during the second display period instead.

6. The display device as claimed in claim 1, wherein the processor extends the first display period of the information to be a third display period in response to a display keep-on event taking place after the first display period, and the screen keeps the information alive during the third display period instead.

7. A screen keep-alive controlling method for a display device, the display device comprising a processor and a screen electrically connected to the processor, the screen keep-alive controlling method comprising the following steps of:
(a) enabling the processor to determine a first display period of information according to complexity of the information; and
(b) enabling the screen to keep the information alive during the first display period.

8. The screen keep-alive controlling method as claimed in claim 7, wherein the information comprises one or a combination of text information, picture information and video information.

9. The screen keep-alive controlling method as claimed in claim 7, wherein the first display period is directly proportional to the complexity of the information.

10. The screen keep-alive controlling method as claimed in claim 7, wherein the step (a) is the following step of:
(a1) enabling the processor to determine the first display period according to the complexity of the information and properties of an application corresponding to the information.

11. The screen keep-alive controlling method as claimed in claim 7, further comprising the following steps of:
(c) in response to a display interrupt event taking place during the first display period, enabling the processor to shorten the first display period of the information to be a second display period; and
(d) enabling the screen to keep the information alive during the second display period instead.

12. The screen keep-alive controlling method as claimed in claim 7, further comprising the following steps of:
(c) in response to a display keep-on event taking place after the first display period, enabling the processor to extend the first display period of the information to be a third display period; and
(d) enabling the screen to keep the information alive during the third display period instead.
